(19) United States
(12) Patent Application Publication
(10) Pub. No.: US 2016/0320859 A1
(43) Pub. Date: Nov. 3, 2016

(54) CUSTOMIZABLE ROTATIONAL COMMAND BUTTON FOR A COMMAND INPUT DEVICE

(71) Applicant: PLAYRAPID, Saint-Remy de Provence (FR)

(72) Inventor: Damien RUBIO, Saint-Remy de Provence (FR)

(21) Appl. No.: 15/141,661

(22) Filed: Apr. 28, 2016

(30) Foreign Application Priority Data
Apr. 29, 2015 (FR) 1553874

(51) Int. Cl. G06F 3/02; A63F 13/24

(52) U.S. Cl. CPC G06F 3/0202; A63F 13/24

(57) ABSTRACT

A command button is provided for a command input device, being rotational about an axis of rotation, and including:
a part, referred to as lower, provided in order to be fixed rotationally about the axis of rotation, on/in a frame of the command input device; and
a part, referred to as upper, fixed in a detachable or removable manner onto the lower part in a direction, referred to as direction of assembly, forming an angle equal to or less than 45° with the axis of rotation.

### BACKGROUND

The present invention relates to a customizable rotational command button for a command input device. It also relates to a kit for producing such a command button, a command input device, such as a game controller, comprising such a command button as well as a method for producing such a command input device.

The field of the invention is the field of command input devices for a games console or a computer, such as a game controller.

The majority of electronic/computer games are controlled by command input devices, also referred to as game controllers.

Each game controller comprises at least one button, also referred to as trigger, movable by means of rotation between a starting and an ending position about a single axis of rotation, which in general is substantially parallel to the front face of the game controller. Such a button can be used either in order to enter a binary command or in order to enter a command the intensity of which depends on the amount of movement of the button with respect to the starting position. For example, the speed of movement of a virtual object in the electronic game is adjusted as a function of the travel of the button with respect to its starting position.

A game controller comprises in general two triggers which are positioned on each side of the game controller on an upper part such that each trigger is actuated by a forefinger of one hand of the user when the latter holds the game controller between their hands. The majority of video games comprise commands which must be entered via the triggers of the game controller. Thus, the triggers of a game controller form part of the most frequently actuated buttons.

This frequent actuation results in rapid wear of the triggers, in particular in the upper part. When these have to be replaced, it is then necessary to detach the frame of the game controller, which is a complex and risky operation for the game controller. In addition, the dimensions of the hand of each user being different, the size of the triggers is not suitable for all users.

In order to alleviate the problem of wear and to respond to the requirement for customization, solutions have been proposed consisting of an additional manipulation part which is fixed onto the upper part of a trigger in a direction substantially perpendicular to the axis of rotation of the trigger. However, in addition to not fully responding to the need for customization, these solutions prove to be insufficiently robust as the additional manipulation part inadvertently becomes detached or breaks. In addition, fixing the manipulation part to the trigger is impractical and involves risks of deterioration of the trigger.

A purpose of the present invention is to overcome the abovementioned drawbacks.

Another purpose of the invention is to propose a customizable, yet robust rotational command button.

Another purpose of the invention is to propose a rotational command button customizable in a more practical manner.

Finally, another purpose of the invention is to propose a rotational command button which can be customized with reduced risks of deterioration for the command button and the command input device.

### SUMMARY

The invention proposes to achieve at least one of the abovementioned aims by means of a command button for a command input device, such as a game controller, rotational about an axis of rotation, said command input device being in particular provided in order to be actuated by a forefinger of the user when the latter holds the command input device between their hands, said command button being characterized in that it comprises or consists of:
a part, referred to as lower, provided in order to be secured rotationally about said axis of rotation, on/in a frame of said command input device, and
a part, referred to as upper, fixed in a detachable or removable manner onto said lower part in a direction, referred to as direction of assembly, forming an angle equal to or less than 45° with said axis of rotation.

Thus, it is possible to customize the rotational command button at will by customizing the upper part of said command button. The lower part remaining fixed, it is not necessary to detach the frame of the command input device. This customization makes it possible to reduce or to increase the overall size of the command button and to modify the material of the upper part coming into contact with the finger of the user, etc.

In addition, the axis of assembly of the upper part together with the lower part forming an angle equal to or less than 45°, there is little or no risk of inadvertent disassembly: the command button thus obtained is therefore more robust.

Moreover, such an axis of assembly makes it possible to fix the upper part to the lower part in a more practical manner because when the upper part is fixed together with the lower part the rotation of the latter is limited.

Finally, the rotational command button according to the invention can be customized with reduced risks of deterioration for the command button and the command input device because fixing the upper part together with the lower part requires little or no rotation of the lower part.

In particular, the lower part can be provided in order to be fixed in the frame of the command input device such that it cannot be detached without partially or fully detaching said frame of said command input device.

Preferably, the direction of assembly can be parallel to the axis of rotation or at least have an angle equal to or less than 5°, which makes it possible to increase the robustness of the assembly of the upper part together with the lower part and to further decrease the risks of inadvertent disassembly.

Advantageously, the direction of assembly may moreover not be parallel to the plane of rotation of the command button, which is the same as the plane of rotation of the lower part.

More particularly, the direction of assembly can present an angle greater than or equal to 45° and in particular an angle comprised between 85° and 95°, with respect to the plane of rotation of the command button.

Preferably, the direction of assembly can be perpendicular to the plane of rotation of the command button.

Thus, the risks of inadvertent disassembly are further reduced or even eliminated.

Advantageously, the upper part can be fixed onto the lower part by rotation or by translation along the axis of assembly.

Preferably, the upper part can be fixed onto the lower part by translation along the axis of assembly, such fixing being simpler, quicker and more ergonomic for the user to carry out.

According to a preferred, but in no way limitative, embodiment, one of the lower and upper parts can comprise a male fixing shape, in particular integral with said part, provided in order to be inserted into a female fixing shape provided on the other one of the lower and upper parts, in particular integral with said part.

Such fixing means make it possible to carry out a robust manual fixing of the upper part onto the lower part, without the use of a fixing tool for mounting/detaching the upper part on/from the lower part and without manipulating an independent fixing means of the upper and lower parts.

In addition, such male/female fixing shapes can be produced during the manufacture of each part, for example by means of moulding.

More particularly, the male fixing shape and the female fixing shape can have a cross section in the form of a “T” or a trapezium.

The command button according to the invention can also comprise a means for locking the upper part in rotation and/or in translation with respect to the lower part, after the upper part is fixed onto the lower part.

Such a locking means is advantageously independent of the means for fixing the upper part onto the lower part so as to ensure a second level of locking in the event of failure of said fixing means.

Such a locking means can comprise a male locking element provided on one of the parts, lower or upper, which is inserted into a female locking element provided on the other one of the lower or upper parts, in a direction perpendicular to the direction of assembly of the upper part together with the lower part, when the upper part is assembled together with the lower part.

Moreover, the upper part can comprise a surface, referred to as manipulation surface, provided in order to receive a press of a finger of a user in order to enter a user command.

According to a particular embodiment, the upper part can include the entire manipulation surface of said command button such that said command button can be manipulated solely by means of said upper part without any access to the lower part when the command button is manipulated.

In other words, the upper part can partially comprise, or constitute all of the surface of the command button for manipulation by the user, i.e. the surface provided in order to enter into contact with a finger of the user and by means of which the user manipulates the command button.

Moreover, at least a part of the contact surface can advantageously comprise a covering having a lower coefficient of hardness and/or a higher coefficient of friction so as to provide a more ergonomic use for the user.

Such a covering can be produced from soft plastic such as TPU or TPE.

The command button according to the invention can be provided rotational, in particular in a recess arranged in the frame of said command input device, between one position referred to as starting position, when said command button is at rest and one position referred to as ending position, when force is applied to said command button with a view to entering a command.

The upper part of the command button can therefore also comprise:
a surface, referred to as starting abutment surface, provided in order to abut against a portion of said frame of said device when said command button is in the starting position so as to adjust said starting position; and/or
a surface, referred to as ending abutment surface, provided in order to abut against a portion of said frame of said device when said command button is in the starting position so as to adjust said ending position.

In this embodiment, the command button consists of two parts, the upper part comprising a starting abutment surface and/or an ending abutment surface against the frame of the command input device when the command button is in the starting position, respectively in the ending position, such that the starting position, respectively the ending position, of the command button can be modified/adjusted.

As a result, according to the invention, the adjustment of the travel of the command button is carried out directly via the upper part of the command button and thus by the command button itself, and not by an external adjustment element attached to the command button and mobile in said command button, as is for example the case in the device of document U.S. Pat. No. 8,480,491 B2. The invention therefore proposes an adjustment of the travel of the command button while retaining the balance and the robustness of the command button. In addition, the adjustment of the travel of the command button according to the invention is more ergonomic because it does not require manipulation with a tool, such as a screwdriver, of an adjustment element external to the command button and mobile within the, or with respect to, the command button.

The command button can comprise the starting abutment surface or the ending abutment surface or both.

According to a preferred embodiment, the command button according to the invention can comprise at least one means for fixing, interchangeably, in one and the same fixing position, at least two upper parts.

In this embodiment, said upper parts can each have an ending abutment surface located at a different angular distance from the frame portion of the command input device against which said ending abutment surface abuts, in particular at a different distance from the edge of a recess arranged in said frame and in which the command button is arranged rotationally. Thus, the upper parts are fixed onto the lower part, always in the same position. By contrast, the upper parts each comprising an ending abutment surface are located at a different distance from the frame portion against which they abut, each upper part allows for a different ending position from the other. It is thus possible to adjust the ending position of the command button by selecting one or other upper part.

Said measured distance for the ending abutment surface can vary within a range between 1° and 15°, from one upper part to another.

Said distance is measured when the command button is in the starting or resting position.

Alternatively or additionally, in this preferred embodiment, the upper parts can each have a starting abutment surface located at a different distance from said same fixing position. Thus, the upper parts are fixed onto the lower part, always in the same position. By contrast, each upper part allows for a different starting position by restricting the command button to a different rotation in the starting position, by means of abutment against a frame portion located on the side of the axis of rotation of the command button and without any force being applied by the user. It is thus possible to adjust the starting position of the command button by selecting an individual upper part.

Said measured distance for the starting abutment surface can vary within a range between 1 mm and 5 mm, from one upper part to another.

More particularly, the lower part can comprise a single position for fixing the upper part onto said lower part.

Each abutment surface can be more or less broad and can in certain cases be limited to a contact in the form of a point. However, it is preferable for the contact surface not to be reduced to a point because this would cause a rapid deterioration of the abutment surface and of the frame of the command input device, in particular with regard to the ending abutment surface. According to another embodiment, which can optionally be combined with the preceding embodiment, the command button can comprise at least one means for fixing the upper part onto said lower part and at least two different positions spaced apart in the plane of rotation of said command button and located at different distances:
from the frame portion against which the starting abutment surface abuts, and/or
from the frame portion against which the ending abutment surface abuts.

In other words, the command button can comprise at least one means for fixing the upper part onto said lower part in at least two different positions which are spaced apart in the rotational path of said lower part.

Thus, with one and the same single upper part, it is possible to adjust the starting position, respectively the ending position, and thus the travel of the command button.

Preferably, the starting abutment surface can be located on the side of a front face of said command button such that it abuts against a frame portion located on the side of a front edge of a recess arranged in the frame and in which said command button is rotated, and in particular an edge of said recess located on the side of a front face of said command input device.

In particular, the starting abutment surface can be located on the side of the axis of rotation of the lower part such that it abuts against a frame portion located on the side of said axis of rotation.

Preferably, the ending abutment surface can be located on the side of a lateral face of said command button such that it abuts against a frame portion located on the side of a lateral edge of a recess in which said command button is rotated, and in particular an edge located on the side of a lateral face of said command input device.

In particular, the ending abutment surface can be located on the side of a lateral face of said command button, and in particular on the side of a lateral face of said upper part which is perpendicular to the axis of rotation of the lower part such that it abuts against a frame portion perpendicular to said axis of rotation.

According to a particular embodiment, the ending abutment surface can be provided at the level of an end facing towards the lower part, in a form that projects from the upper part, and thus from the lower part, on the side of a lateral face of said upper part, and thus of the lower part, perpendicular to the axis of rotation of the lower part and thus of the command button.

According to a further aspect of the same invention, a kit for producing a command button according to the invention is proposed, comprising:
at least one lower part, and
at least two upper parts being able to be mounted interchangeably on said lower part in one and the same fixing position.

More particularly, each of the upper parts forming part of the kit according to the invention can each have:
a starting abutment surface located at a different distance from said same fixing position; and/or
an ending abutment surface located at a different angular distance from the frame portion of the command input device against which said ending abutment surface abuts.

Such a kit makes it possible to produce a command button in which:
the base part is fixed onto a command input device, and
the upper part can be changed at will, in particular with a view to modifying and adjusting the starting position and/or ending position, and thus the travel of the command button.

According to another aspect of the same invention, a command input device such as a game controller is proposed, comprising at least one command button according to the invention, in particular arranged rotationally in a recess arranged in the frame, or the shell, of said command input device.

In particular, the command input device according to the invention can comprise two lateral faces, each provided in order to be held by a hand of the user, said device comprising, on the side of each of said lateral faces, at least one command button according to the invention, each arranged rotationally in a recess arranged in the frame of said device and arranged in order to be able to be actuated by a forefinger of the user.

According to a further aspect of the same invention, a method for producing a command input device according to the invention is proposed, characterized in that it comprises the following steps carried out for at least one command button according to the invention:
opening a frame of said device at least partially,
securing the lower part free in rotation to said device, in particular in a recess provided in the frame of said device,
closing said frame of said device, and
assembling the upper part on said lower part.

In a particular embodiment, the method according to the invention can also comprise a step of selecting an upper part from at least two upper parts, each of said upper parts being able to be mounted interchangeably on said lower part at one and the same fixing position, and each having:
a starting abutment surface located at a different distance from said same fixing position; and/or
an ending abutment surface located at a different angular distance from the frame portion of the command input device against which said ending abutment surface abuts.

### BRIEF DESCRIPTION OF THE DRAWINGS

Further advantages and characteristics will become apparent on examination of the detailed description of embodiments which are in no way limitative, and the attached drawings, in which:

FIG. 1 is a diagrammatic representation of a non-limitative example of a command button according to the invention;

FIG. 2 is a diagrammatic representation of the lower part of the button in FIG. 1;

FIGS. 3a and 3b are diagrammatic representations of the upper part of the button in FIG. 1 in two different views;

FIGS. 4a and 4b are diagrammatic representations of an example of adjustment of the ending position with a command button arranged in the frame of a game controller represented in a partial manner; and

FIG. 5 is a diagrammatic representation of an example of adjustment of the starting position with a command button arranged in the frame of a game controller represented in a partial manner.

### DETAILED DESCRIPTION

It is well understood that the embodiments that will be described hereinafter are in no way limitative. Variants of the invention can in particular be envisaged comprising only a selection of the characteristics described below in isolation from the other described characteristics, if this selection of characteristics is sufficient to confer a technical advantage or to differentiate the invention with respect to the state of the prior art. This selection comprises at least one preferably functional characteristic without structural details, or with only a part of the structural details if this part alone is sufficient to confer a technical advantage or to differentiate the invention with respect to the state of the prior art.

In particular, all the described variants and embodiments may be combined if there is no objection to this combination from a technical point of view.

In the figures and in the remainder of the description, the elements common to several figures retain the same reference numbers.

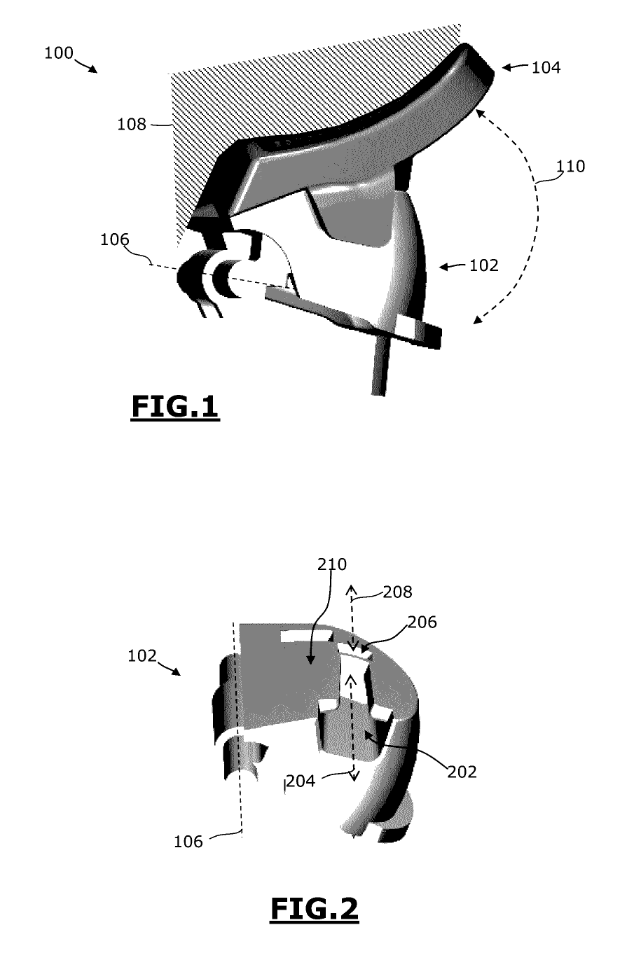

FIG. 1 is a diagrammatic representation of a non-limitative embodiment example of a command button according to the invention.

The rotational command button 100 shown in FIG. 1 comprises a lower part 102, also referred to as base part, and an upper part 104, also referred to as manipulation part, detachably assembled together.

The lower part 102 is provided in order to be fixed rotationally onto a frame of a command input device, hereinafter also referred to as “game controller”, at its axis of rotation 106. More particularly, the lower part 102 is provided in order to be fixed in the frame of a game controller such that it cannot be mounted/detached without partially or fully detaching said frame.

The command button 100 is rotational in a plane 108 perpendicular to the axis of rotation 106, along a trajectory 110 in the form of an arc of a circle having the axis of rotation 106 as the centre.

FIG. 2 is a diagrammatic representation of the lower part 102 of the command button in FIG. 1. The lower part 102 comprises a female fixing shape 202, with a cross section in the form of a trapezium (or inverted “T”), provided in order to receive, in a direction 204 parallel to the axis of rotation 106 and perpendicular to the plane of rotation 108, a male fixing shape provided on the upper part 104 for fixing the upper part 104 together with the lower part 102 in one direction and for removing the upper part 104 from the lower part 102 in the opposite direction.

This female fixing shape 202 allows for fixing one or more upper parts onto the lower part 102 in a single fixing position.

The lower part 102 also comprises a female locking shape 206, with a rectangular cross section, provided in order to receive, in a direction 208 perpendicular to the axis of rotation 106 and parallel to the plane of rotation 108, a male locking shape provided on the upper part 104, when the upper part is assembled together with the lower part.

Direction 208 is substantially perpendicular to the upper surface 210 of the lower part 102 and direction 204 is substantially parallel to the upper surface 210 of the lower part 102.

In the example shown, the lower part 102 comprises a single fixing position, determined by the female fixing shape 202 and making it possible to fix different upper parts removably and interchangeably.

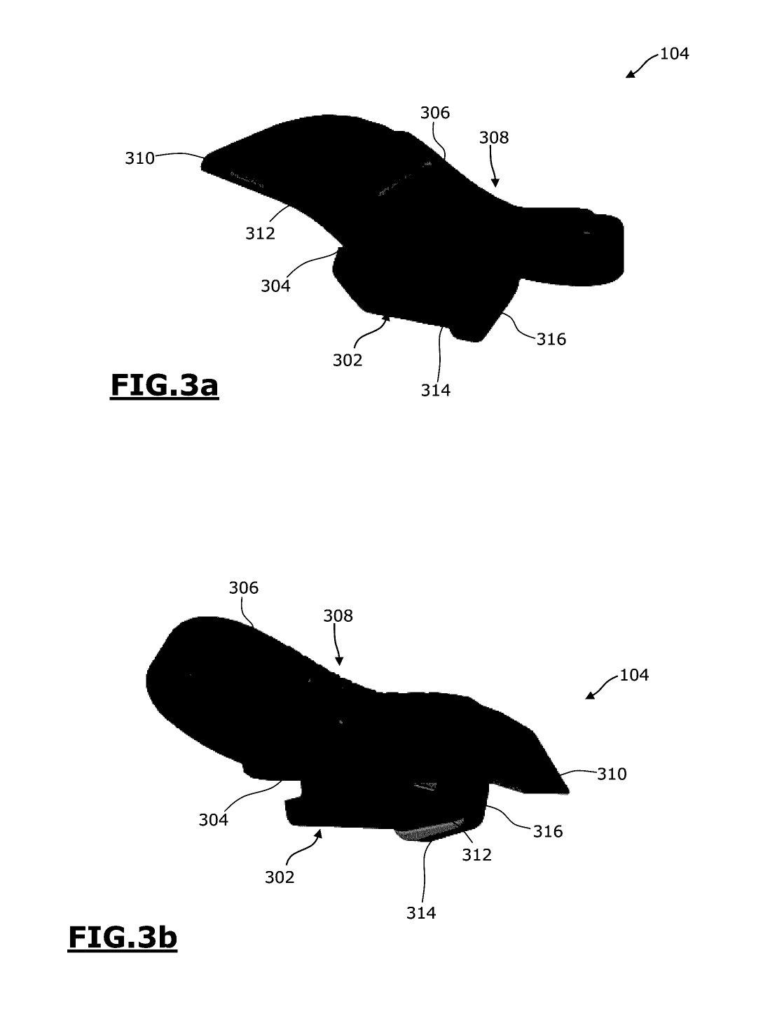

FIGS. 3a and 3b are diagrammatic representations of the upper part 104 of the command button 100 in FIG. 1 in two different views.

The upper part 104 comprises a male fixing shape 302, with a cross section in the form of a trapezium (or inverted “T”), provided in order to be inserted, in the direction 204 into the female fixing shape 202 provided on the lower part 102 in order to fix the upper part 104 onto the lower part 102.

The upper part 104 also comprises a male locking shape 304, with a rectangular cross section, provided in order to be inserted, in the direction 208, into the female locking shape 206 provided on the lower part 102, when the upper part 104 is assembled together with the lower part 102. The male 304 and female 206 locking shapes cooperate with each other in order to maintain the upper part 104 in a fixed manner on the lower part 102 and to avoid the inadvertent disassembly of the upper part 104.

The upper part 104 comprises an upper surface 306 provided in order to come into contact with a finger of the user, in particular with a forefinger of the user, when the user applies a pressure to the command button 100 in order to enter a command. On this upper surface 306, the upper part comprises a flexible covering 308 having a higher friction coefficient. This covering 308 is produced from TPE.

In the example shown, the user can only actuate the command button 100 by means of the upper surface 308 of the upper part 104.

The upper part 104 can also comprise an abutment surface 310, referred to as starting abutment surface, situated on the side of the axis of rotation 106 of the command button when the upper part 104 is assembled together with the lower part 102. This starting abutment surface 310 is provided in order to come into contact with a frame portion of a game controller, when the command button 100 is fixed onto said game controller and when the command button is in the resting position in which no force is applied to the command button. More particularly, the starting abutment surface 310 is provided in order to come into contact against a frame portion located on the side of a front edge of a recess, arranged in the frame, in which said command button is rotated and in particular an edge of said recess located on the side of a front face of said command input device and on the side of the axis of rotation 106.

By adjusting the distance, marked by the arrow 312, between the starting abutment surface 310 and the fixing position of the upper part 104 on the lower part 102, it is possible to adjust the starting position of the command button 100. The greater the distance 312, the more the command button 100 will be “pressed in” or “rotated” in its starting position, without any force being applied to the command button 100.

Thus, in the example described, the adjustment of the starting position is carried out by providing several upper parts 104 each having a distance 312 between its starting abutment surface 310 and the different fixing position of the other upper parts. Thus, the user can modify/adjust the starting position, in a rapid and ergonomic manner, by replacing one upper part with another upper part.

The upper part 104 can also comprise an abutment surface 314, referred to as ending abutment surface, situated on a lateral side of the upper part 104 such that it abuts against a frame portion located on the side of a lateral edge of a recess, arranged in the frame of the game controller and in which the command button 100 is rotated and in particular an edge located on the side of a lateral face of the game controller.

In the example shown, the ending abutment surface 314 is provided at one end facing towards the lower part 102, of a shape 316 projecting from the upper part 104, and from the lower part, on the side of a lateral face of said upper part 104, and of the lower part, on the side of a lateral face of said upper part 104 perpendicular to the axis of rotation 106 of said lower part 102.

By adjusting the angular distance between the ending abutment surface 314 and the edge of the frame against which the ending abutment surface 104 comes into contact, it is possible to adjust the ending position of the command button 100. The smaller the angular distance 318, the more quickly the command button 100 will reach its ending position and the shorter will be the distance to be travelled in order to reach the ending position.

Thus, in the example described, the adjustment of the ending position is carried out by providing several upper parts 104 each having such an angular distance (between its ending abutment surface 314 and the frame portion facing said ending abutment surface 314 against which said ending abutment surface 314 abuts) that is different from the other upper parts. Thus, the user can modify/adjust the ending position, in a rapid and ergonomic manner by replacing one upper part with another upper part.

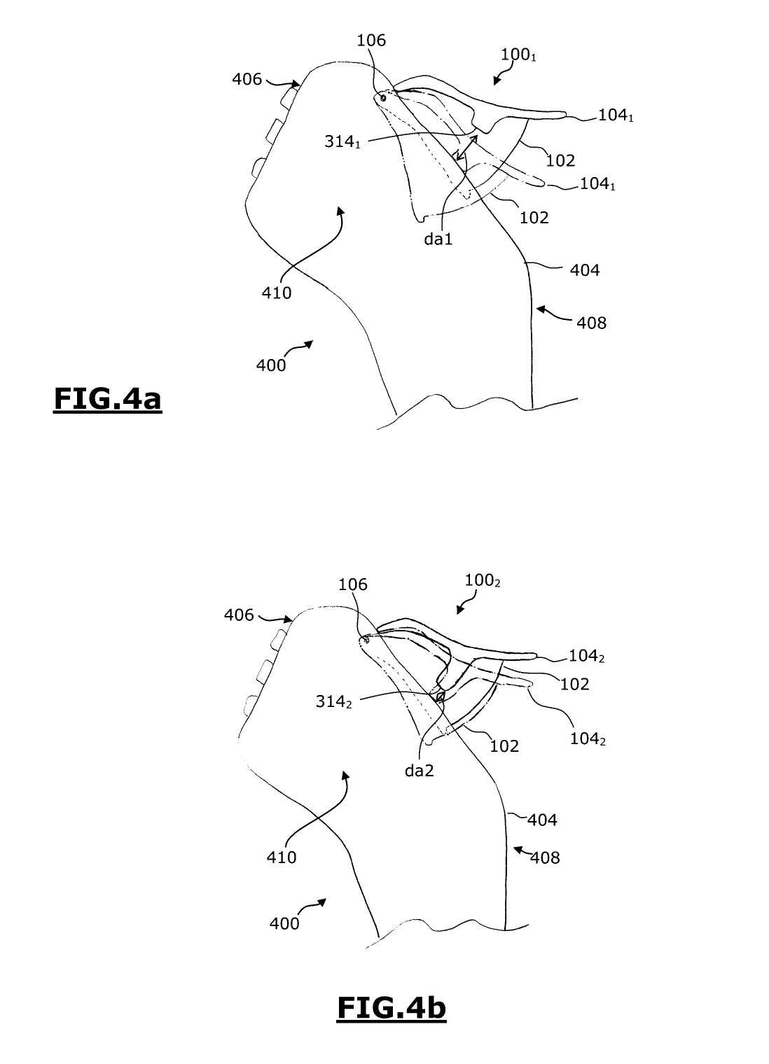

FIGS. 4a and 4b give a representation of an example of adjustment of the ending position with a command button arranged in the frame of a game controller represented in a partial manner.

FIGS. 4a and 4b represent in an incomplete manner a game controller 400 comprising a command button, respectively 100₁ in the case of FIG. 4a and 100₂ in the case of FIG. 4b, mounted rotationally in a recess arranged in the frame 404 of the game controller 400. The game controller 400 comprising a front face 406 directed towards the user when the game controller 400 is held by the user, a rear face 408 opposite to the front face and a lateral face 410 joining the front face 406 and the rear face 408.

In each of FIGS. 4a and 4b, the command button, 100₁ and 100₂ respectively, is shown by a solid line in its starting position and by a dotted line in its ending position.

In FIG. 4a, the command button 100₁ is formed by a lower part, for example the lower part 102 in FIG. 1. In FIG. 4a, the command button 100₁ comprises an upper part 104₁, the ending abutment surface 314₁ of which is located at an angular distance, marked da1, from the frame portion against which it abuts in the ending position, when the command button 100₂ is in its starting position.

In FIG. 4b, the command button 100₂ comprises the same lower part 102 as the command button 100₁ in FIG. 4a. Unlike in FIG. 4a, in FIG. 4b, the command button 100₂ comprises an upper part 104₂ the ending abutment surface 314₂ of which is located at an angular distance marked da2 from the frame portion against which it abuts in the ending position, when the command button 100₂ is in its starting position.

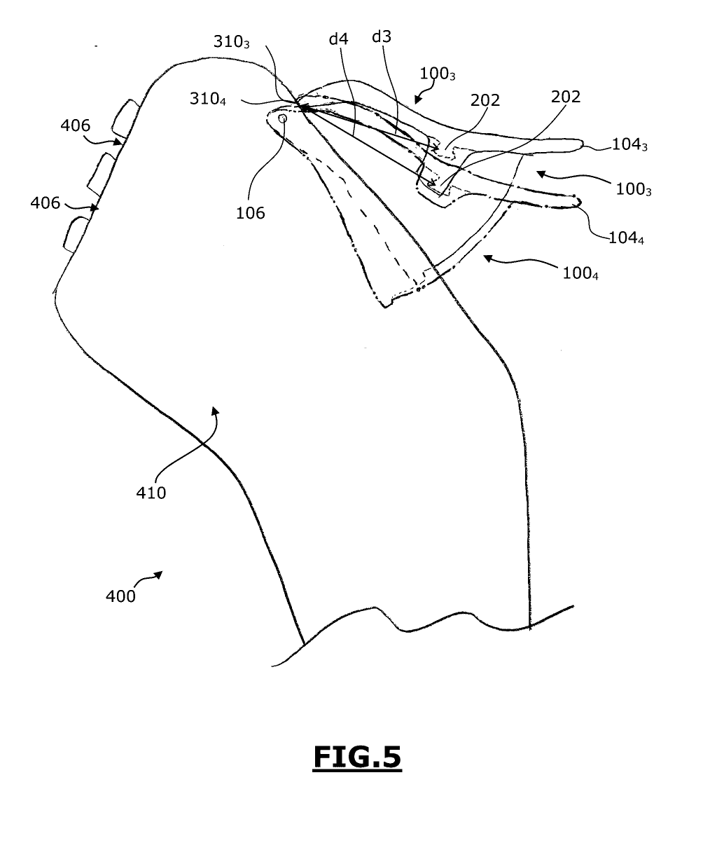

The angular distance da2 is smaller than the angular distance da1. As a result, in the case of the command button 100₂ the ending position of the button is reached with a smaller rotation, i.e. with a shorter travel, in other words more quickly, compared with the command button 100₁. FIG. 5 is a representation of an example of adjustment of the starting position with a command button arranged in the frame of a game controller represented in a partial manner.

FIG. 5 represents in an incomplete manner a game controller 400 comprising a command button, respectively 100₃ and 100₄, mounted rotationally in a recess arranged in the frame 404 of the game controller 400. The game controller 400 comprising a front face 406 directed towards the user when the game controller 400 is held by the user, a rear face 408 opposite to the front face and a lateral face 410 joining the front face 406 and the rear face 408.

In FIG. 5, the command buttons 100₃ and 100₄ are represented in their starting position. The command button 100₃ is represented by a solid line and the command button 100₃ is represented by a dotted line.

The command button 100₃ is formed by a lower part, for example the lower part 102 in FIG. 1. The command button 100₃ comprises an upper part 104₃ the starting abutment surface of which 310₃ is located at a distance, marked d3, with respect to the fixing position of the upper part 104₃ on the lower part 102.

The command button 100₄ comprises the same lower part 102 as the command button 100₃. Unlike the command button 100₃, the command button 100₄ comprises an upper part 104₄ the starting abutment surface 310₄ of which is located at a distance, marked d4, with respect to the fixing position 202 of the upper part 104₄ on the lower part 102.

The distance d3 is smaller than the angular distance d4. As a result, in the case of the command button 100₄ the starting position is further advanced, i.e. presents a greater rotation, compared with the command button 100₃, without pressure being applied by the user.

Of course, the examples represented in FIGS. 4a and 4b can be combined with the examples represented in FIG. 5 such that one and the same upper part carries out both an adjustment of the starting position of the command button and an adjustment of the ending position of the command button. Thus, each of the upper parts 104₃ and 104₄ can comprise an ending abutment surface 314₁ or 314₂.

In the examples described, the upper parts are fixed onto the lower part in one and the same single fixing position realized by the female shape 202.

According to an embodiment, not shown in the FIGURES, the upper part or parts can be fixed onto the lower part in at least two fixing positions spaced apart in the plane of rotation 108, providing:
several means for fixing onto the lower part, for example several male or female fixing shapes, such as the female fixing shape 202; and/or
several means for fixing onto the upper part, for example several male or female fixing shapes, such as the male fixing shape 302.

Of course, the invention is not limited to the examples that have just been described.

1. A command button for a command input device, being rotational about an axis of rotation, comprising:
a part, referred to as lower, provided in order to be fixed rotationally about said axis of rotation, on/in a frame of said command input device; and
a part, referred to as upper, detachably or removably fixed onto said lower part in a direction, referred to as direction of assembly, forming an angle less than or equal to 45° with said axis of rotation.

2. The button according to claim 1, characterized in that the direction of assembly is parallel to the axis of rotation.

3. The button according to claim 1, characterized in that the direction of assembly is not parallel to the plane of rotation of the lower part, and is in particular perpendicular to said plane of rotation.

4. The button according to claim 1, characterized in that one of the lower and upper parts comprises a male fixing shape, provided in order to be inserted into a female fixing shape provided on the other one of the lower and upper parts, in said direction of assembly.

5. The button according to claim 1, characterized in that it comprises a means for locking the upper part in rotation and/or in translation with respect to the lower part, after the upper part is fixed onto the lower part.

6. The button according to claim 1, characterized in that the upper part comprises a surface, referred to as manipulation surface, provided in order to receive a press of a finger of a user in order to enter a command.

7. The button according to claim 1, characterized in that at least a part of the contact surface comprises a covering having a lower coefficient of hardness and/or a higher coefficient of friction.

8. The button according to claim 1, being provided rotational between one position referred to as starting position, when said command button is at rest and one position referred to as ending position, when force is applied to said command button with a view to entering a command, said upper part comprising:
a surface, referred to as starting abutment surface, provided in order to abut against a portion of said frame of said device when said command button is in the starting position so as to adjust said starting position; and/or
a surface, referred to as ending abutment surface, provided in order to abut against a portion of said frame of said command input device when said command button is in the ending position, so as to adjust said ending position.

9. The button according to claim 8, characterized in that the lower part comprises at least one means for fixing, interchangeably, in one and the same fixing position, at least two upper parts, each having:
a starting abutment surface located at a different distance from said same fixing position; and/or
an ending abutment surface located at a different angular distance from the frame portion of the command input device against which said ending abutment surface abuts.

10. The button according to claim 8, characterized in that it comprises at least one means for fixing the upper part onto said lower part in at least two different positions spaced apart in the plane of rotation of said command button and located at different distances:
from the frame portion against which the starting abutment surface abuts, and/or
from the frame portion against which the ending abutment surface abuts.

11. The button according to claim 8, characterized in that the starting abutment surface is located on the side of the axis of rotation of the lower part such that it abuts against a frame portion located on the side of said axis of rotation.

12. The button according to claim 8, characterized in that the ending abutment surface is located on the side of a lateral face of said command button such that it abuts against a frame portion located on the side of a lateral edge of a recess in which said command button is rotated, and in particular an edge located on the side of a lateral face of said command input device.

13. A kit for producing a command button according to claim 1, comprising:
at least one lower part; and
at least two upper parts being able to be mounted interchangeably on said lower part.

14. A command input device such as a game controller, comprising at least one command button according to claim 1.

15. The device according to claim 14, characterized in that it comprises two lateral faces, each provided to be held by a hand of the user, said device comprising, on the side of each of said lateral faces, at least one command button according to claim 1, each arranged in order to be actuated by a forefinger of the user.

16. A method for producing a command input device according to claim 1, characterized in that it comprises the following steps carried out for at least one command button:
opening a frame of said device at least partially;
fixing the lower part free in rotation to said device;
closing said frame of said device; and
assembling the upper part onto said lower part.
